(19) United States
(12) Patent Application Publication
(10) Pub. No.: US 2014/0095104 A1
(43) Pub. Date: Apr. 3, 2014

(54) Method And Apparatus To Monitor The Condition Of An Apparatus

(71) Applicant: Control Techniques Limited, Newtown (GB)

(72) Inventors: Rhys Marc Owen, Llanwnog (GB); Simon David Hart, Welshpool (GB)

(73) Assignee: Control Techniques Limited, Newtown (GB)

(21) Appl. No.: 14/044,294

(22) Filed: Oct. 2, 2013

(30) Foreign Application Priority Data
Oct. 2, 2012 (GB) 1217622.8

(51) Int. Cl. G01K 1/02

(52) U.S. Cl. CPC G01K 1/026
USPC 702/130

(57) ABSTRACT

A method and apparatus to monitor the condition of an apparatus (e.g a variable speed drive), the apparatus comprising: a processor, a plurality of devices and a plurality of temperature sensors, each sensor associated with a device, the processor being arranged in use to: determine, for each of a plurality of sensors, the temperature of the associated device based on the temperature sensed by the sensor and the mode of operation of the device; compare the determined temperatures for each device with stored data relating to the mode of operation of the apparatus; and based on the comparison determine whether the apparatus is operating as expected in the mode of operation.

### CROSS-REFERENCE TO RELATED APPLICATION

This application claims the benefit and priority of Great Britain Patent Application No. 1217622.8 filed Oct. 2, 2012. The entire disclosure of the above application is incorporated herein by reference.

### FIELD

The present technique relates to monitoring the operating condition of an apparatus, the apparatus comprising a variety of devices and a plurality of temperature sensors.

### DRAWINGS

The proposed technique will now be described by way of example only with reference to the accompanying drawings, in which:

FIG. 1 shows an example of an apparatus in which the proposed technique may be implemented;

FIG. 2 shows an example of a thermal profile using absolute values of temperature;

FIG. 3 shows an example of a thermal profile using differential values of temperature;

FIG. 4 shows a further example of an apparatus in which the proposed technique may be implemented;

FIGS. 5, 6 and 7 show examples of thermal profiles using differential values of temperature; and

FIG. 8 is a flow chart illustrating the proposed technique.

### SUMMARY

A method and apparatus for monitoring the condition of an apparatus is described. In the following description, for the purposes of explanation, numerous specific details are set forth in order to provide a thorough understanding of the present invention. It will be apparent, however, to one skilled in the art that the technique may be practised without these specific details. In other instances, well-known structures and devices are shown in block diagram form in order to avoid unnecessarily obscuring the present invention.

In one aspect, a method for monitoring the condition of an apparatus is described. In other aspects, the proposed technique encompasses apparatus and a computer-readable medium configured to carry out the foregoing actions, as well as a data carrier carrying thereon or therein data indicative of instructions executable by processing means to cause those means to carry out the foregoing actions. Examples are CD-ROMs, memory sticks, dongles, transmitted signals, downloaded files etc. In particular, the method may be implemented in an apparatus for which temperature is a concern.

### DETAILED DESCRIPTION

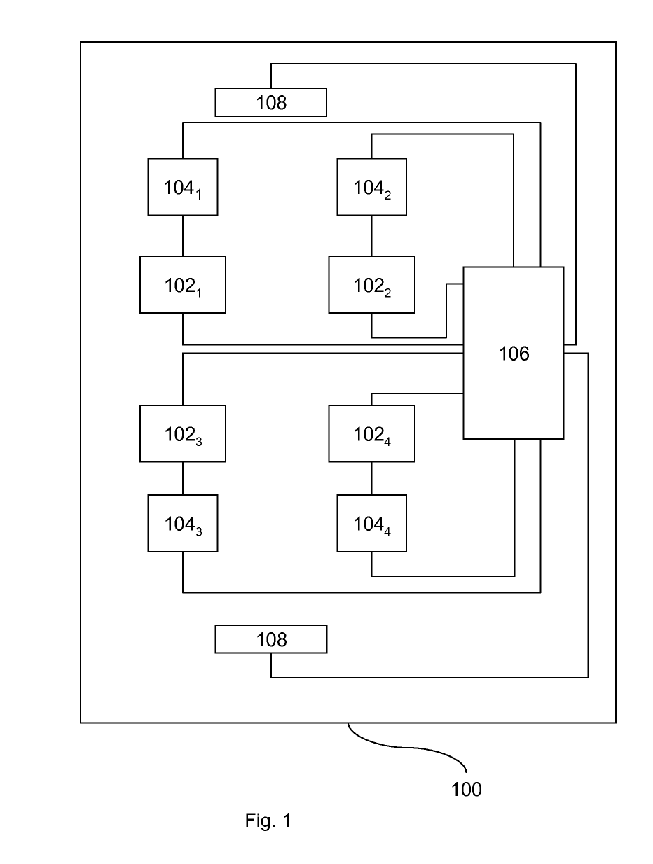

FIG. 1 shows an example of an apparatus in which the proposed technique may be implemented. The apparatus 100 comprises a plurality of devices 102, a plurality of temperature sensors 104, a microprocessor 106 to control devices 102 and to receive inputs from temperature sensors 104 and one or more components 108 to cool the devices 102 within the apparatus 100.

Clearly the apparatus may comprise more devices, temperature sensors etc than those shown. The apparatus shown is simplified for the understanding of the proposed technique and an apparatus as implemented is likely to include many more components. Devices 102 may be electronic devices such as discrete semi-conductor devices (for instance diodes, transistors etc.) or integrated circuits (ICs) or individual units (e.g. power supply etc) or other devices such as mechanical devices, electrical devices or physical parts (e.g. PCB temperature or enclosure temperature). Temperature sensors may comprise thermistors or the like. Cooling components 108 may be a fan or ventilation openings controlled by one or more flaps or other cooling components to cool the devices 102 within the apparatus 100.

In operation the microprocessor controls the devices 102 according to an operating mode of the apparatus. For example, the operating mode could, for instance, be a cooling component 108 (e.g. a fan) operating when a device is working at full power, this being a subset of the devices of the apparatus, or an operating mode in which the cooling component 108 is operating and all devices are in a sleep mode or an operating mode in which a cooling component 108 is operating and the devices are not operating or any other operating mode.

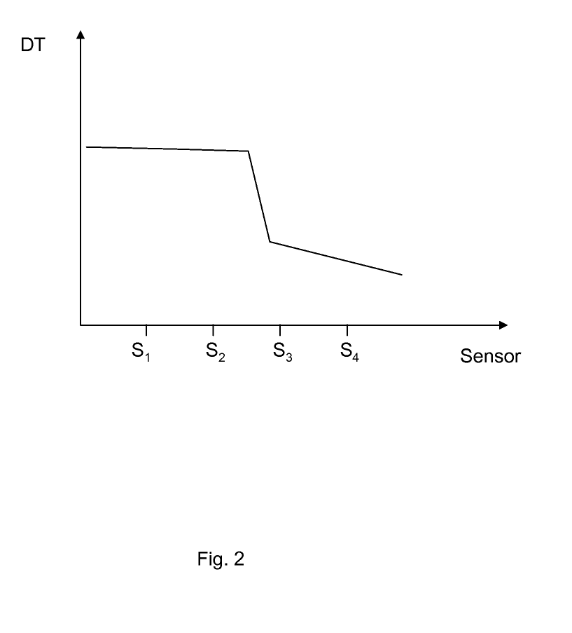

The microprocessor stores data relating to expected temperatures when devices are operating in a given operating mode of the apparatus. This data may be in the form of temperature profiles for instance as shown in FIG. 2.

FIG. 2 shows a stored profile with expected determined temperatures DTₙ at the relevant device 102ₙ for a given operating mode of apparatus 100. The actual determined temperature DTₙ of the device 102ₙ is determined from the actual temperature Tₙ sensed by the associated sensor 104ₙ (indicated in FIG. 2 as Sₙ) and the current mode of operation of the associated device 102ₙ in the current operating mode of the apparatus.

For instance:

DTₙ=Tₙ×mₙ×d

Where Tₙ is the actual temperature sensed by the sensor 104ₙ

mₙ is the operating performance of the associated device 102ₙ e.g. 0% to 100%

d is the distance of sensor 104ₙ from the associated device 102ₙ

Or alternatively:

DTₙ=Tₙ+(k*accI*mₙ*d)

Where Tₙ is the actual temperature sensed by the sensor 104ₙ

m is the operating performance of the associated device 102ₙ e.g. 0% to 100%

d is the distance of sensor 104ₙ from the associated device 102ₙ

k is a coefficient determined during testing,

accI is the accumulated current through the switching device

Thus the determined temperature DTₙ is not simply the temperature sensed remotely by the sensor 102 but it is intended to be a more accurate estimation of the actual temperature of the device in the specified operating mode. Where the device 102 is a discrete semiconductor device (e.g. a transistor, a diode or the like) the determined temperature DTₙ gives an estimation of the actual junction temperature of the device.

Other temperature profiles may be stored for other operating modes of the device for example: one or more fans on or off, one or more devices on or off, or ratios (0 to 100%) of device off and on, and the current passing through the devices etc.

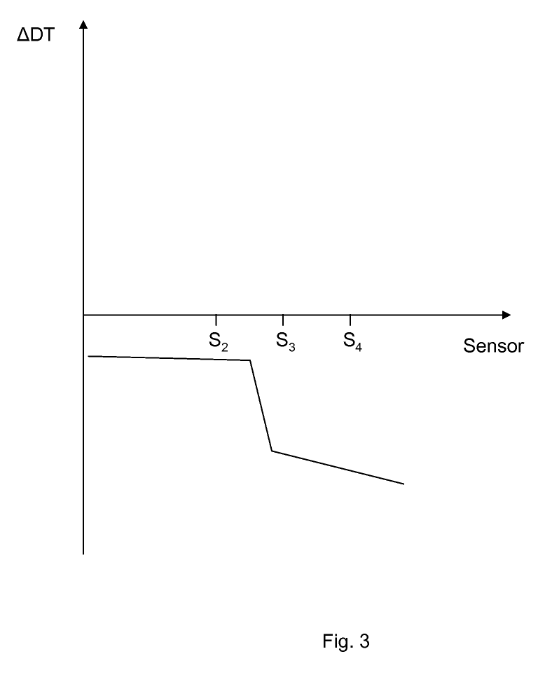

The profile may be differential profiles i.e. profiles that indicate the differences between the temperature determined from one sensor and the temperature determined from another sensor. For instance, as shown in FIG. 3, the temperature profile may be related to the difference between the determined temperature of the device 102₁ and the determined temperature of each other device of relevant to the profile.

The apparatus monitors for conditions such as an incorrectly installed fan, blocked inlet or outlet vents, a clogged fan, a worn out fan, an unstable fan operation or other operating conditions of the apparatus. This monitoring is based on the stored temperature profile data. The stored data may relate to an expected temperature profile for a given operating condition and may relate to a faulty operating condition. For instance, the stored data may include a temperature profile relating to the expected temperature profile for a fan installed the wrong way around. If the microprocessor determines that the temperature profile of the apparatus is similar to the stored temperature profile relating to the expected temperature profile for a fan installed the wrong way around, then an alert may be issued with this as the detected fault.

The operation of the system will now be described. During operation of the apparatus 100 the microprocessor 106 receives signals from and sends signals to other components of the apparatus e.g. electronic devices 102, the sensors 104 and the fans 108. At any point during operation of the apparatus, the microprocessor is aware of how components are operating. The microprocessor 106 receives input from the temperature sensors 104 situated around the apparatus 100. When the temperature sensed via a sensor 104 is equal to or greater than a threshold value, this triggers the microprocessor to undertake a review of the temperatures within the apparatus 100.

To this end, the microprocessor reads the temperature sensed by the sensors 104 and, for each sensor 104ₙ relevant to the operating mode of the apparatus, determines the temperature DTₙ indicating a current temperature of the device 102ₙ associated with the sensor 104. The microprocessor then determines the differences ΔDT in the determined temperatures DTₙ and compares these determined differences ΔDTₙ against the stored profile for the relevant sensors for the current operating mode of the apparatus.

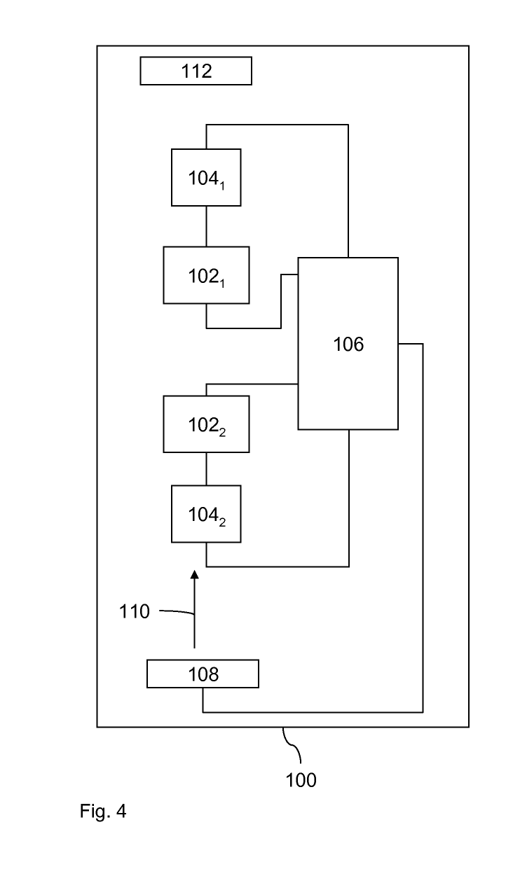

For example FIG. 4 shows a simplified apparatus 100 comprising two devices 102₁ and 102₂, two sensors 104₁ and 104₂, a microprocessor 106 and a fan 108. Fan 108, when operating correctly, causes air to flow in the direction of arrow 110. Thus cool air from outside the apparatus 100 is drawn into the apparatus to cool device 102₂ and then device 102₁ and then exits the apparatus e.g. via a grill 112.

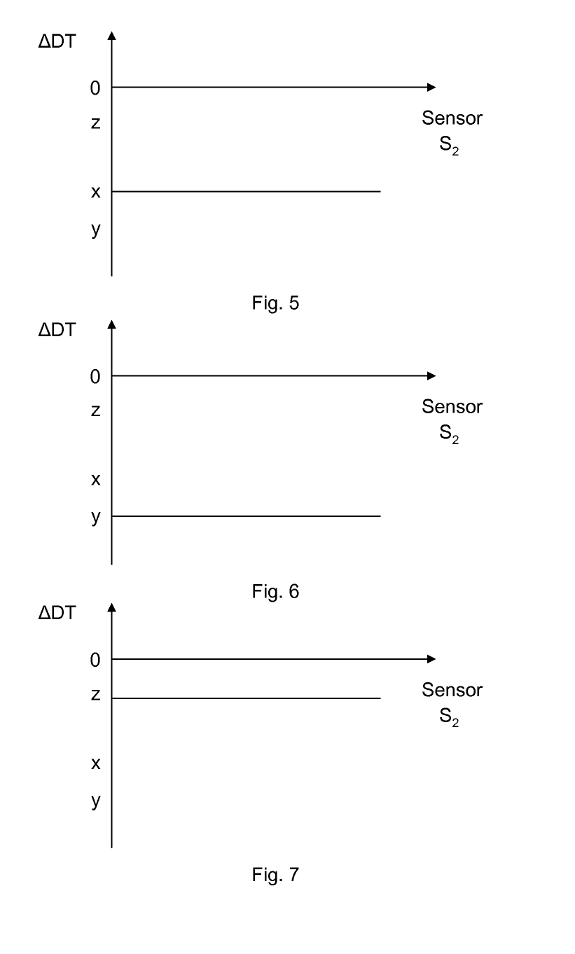

The microprocessor stores temperature profiles relating to the sensors 104₁ and 104₂ for various operating modes of the device. FIGS. 5, 6 and 7 show an example of three temperature profiles stored for the apparatus shown in FIG. 4. FIG. 5 shows an example temperature profile for the determined temperature differential ΔDT with respect to the determined temperature of device 102₁ for the following conditions:

1. Fan on

2. 102₁ on 100%

3. 102₂ off 0%.

For this profile the difference in temperature between the temperature determined from the reading of sensor 104₁ and the determined temperature of sensor 104₂ is indicated as a value of x. This is the expected difference in determined temperature ΔDT when the above operating conditions are in effect.

FIG. 6 shows an example temperature profile for the determined temperature differential ΔDT with respect to the determined temperature of device 102₁ for the following conditions:

1. Fan on

2. 102₁ on 100%

3. 102₂ on 100%.

In this case the determined temperature differential ΔDT i.e. the difference between the determined temperature based on the reading from 104₁ and the determined temperature based on sensor 104₂ is given as y. This is the expected difference in determined temperature ΔDT when the above operating conditions are in effect.

FIG. 7 shows an example temperature profile for the determined temperature differential ΔDT with respect to the determined temperature of device 102₁ for the following conditions:

1. Fan on

2. 102₁ off (0%)

3. 102₂ off (0%).

In this case the determined temperature differential ΔDT i.e. the difference between the determined temperature based on the reading from 104₁ and the determined temperature based on sensor 104₂ is given as z. This is the expected difference in determined temperature ΔDT when the above operating conditions are in effect.

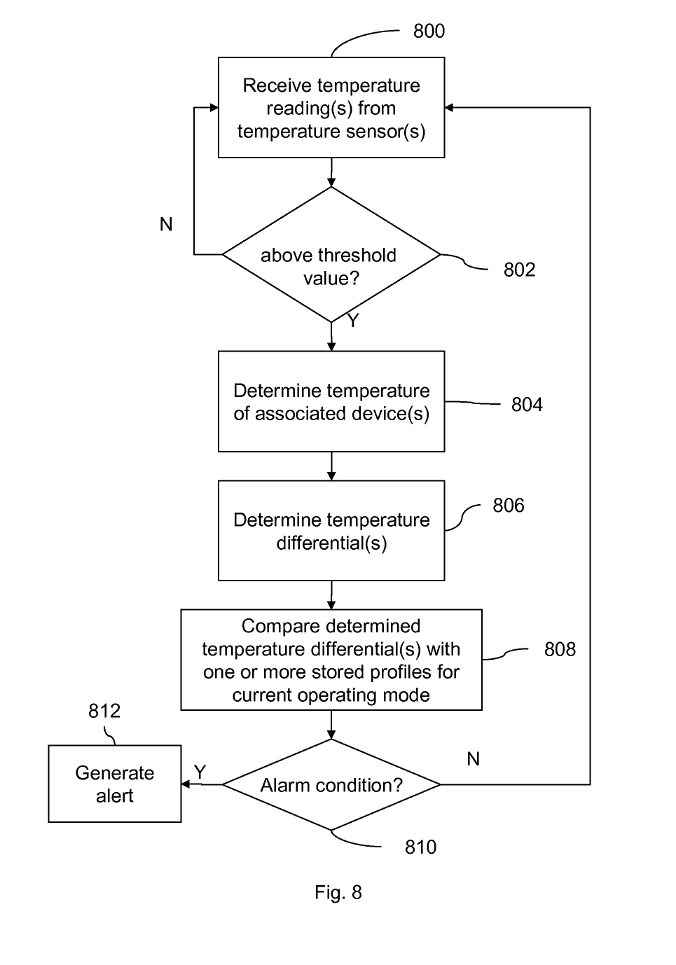

The operation of the system shown in FIG. 4 will now be described in relation to FIG. 8. During operation of the apparatus 100 the microprocessor 106 receives signals from and sends signals to the other components of the apparatus e.g. electronic devices 102, the sensors 104 and the fan 108. At any point during the operation of the apparatus, the microprocessor 106 is aware of how components are operating. The microprocessor 106 receives inputs from the temperature sensors 104. When the temperature sensed by a sensor 104 is equal to or greater than a threshold value, this triggers the microprocessor to undertake a review of the temperatures within the apparatus 100.

To this end the microprocessor receives (operation 800) the temperature readings from the first temperature sensor 104₁ and the second temperature sensor 104₂. The microprocessor then determines if any of the sensed temperatures are above a trigger threshold (operation 802). If not, the microprocessor returns to receiving the temperature reading (operation 800). If a sensed temperature is above a trigger threshold, for each relevant sensor, microprocessor (operation 804) determines the temperature DTₙ of a device indicating a current temperature of the device 102ₙ associated with the sensor 104ₙ. The microprocessor then (operation 806) determines the difference ΔDT between the determined temperature of the first device and the determined temperature of the second device and then the microprocessor (operation 808) compares this determined difference ΔDT against the stored profile for the relevant temperature sensors and the current operating mode of the apparatus. On the basis of this comparison, the microprocessor (operation 810) may determine whether the apparatus is operating as expected for the current operating mode and that there is not an alarm condition (operation 810 answered in the negative) or may determine that the apparatus is not operating as expected for the current operating mode and that there is an alarm condition (operation 810 answered in the positive). When the microprocessor (operation 810) determines that the apparatus is operating as expected for the current operating mode and that there is not an alarm condition, then the microprocessor returns to monitoring the sensed temperatures (operation 800). When the microprocessor (operation 810) determines that the apparatus is not operating as expected for the current operating mode and that there is an alarm condition (operation 810 answered in the positive), then the microprocessor may cause an alert to be issued (operation 812). This may take the form of a visual alert to a user of the apparatus or a message sent to a remote destination or the like.

For example, for the operating mode related to the profile shown in FIG. 6, in which a fan is on and both devices 102₁ and 102₂ are fully on, the profile for the difference in temperature between the temperature determined from the reading of the sensor 102₁ and the temperature determined from the reading from sensor 104₂ shows that the temperature at the sensor 104₁ should be around +y (i.e., the determined temperature of device 102₂ should be around y less than the determined temperature from the reading given by sensor 102₁ for the current operating mode of the apparatus). If however the fan 108 is not working the determined temperature differential may be less than y. In this case the microprocessor may determine that there is a fault and can provide an alert local to the apparatus or to a remote destination e.g. by wireless transmission. In a similar scenario, should the fan 108 be installed incorrectly so that the direction of blow of fan 108 is in the reverse direction to that indicated by arrow 110, the temperature determined from the reading of sensor 104₁ may be less than that of 104₂. From this the microprocessor may determine that the fan is incorrectly installed and also alert the user.

During manufacture, incorrect fan installation in the product may be detected by sensing the direction of the blown air or the direction of rotation of the blade. Detecting an incorrect mounting of a fan in the field is currently quite difficult without difficult checks or putting additional sensors into the product, incurring extra cost.

The proposed technique uses sensors already fitted to the apparatus to measure device temperatures within a product and compare the reading from these sensors to thermal profiles stored in the software to determine the blown air direction or even the absence or presence of blown air. The devices in the product are of varying distances and positions from the fan so the temperature profiles within the product will vary according to the blown air direction, speed, operating mode and other variables in the system. Early warnings can be presented accordingly.

The apparatus described may be provided in variable speed drives, for example as used in manufacturing. These now typically include an installer replaceable fan that is usually manufactured in such a way that the supporting structure of the fan is symmetrical in all three axes allowing the fan to be mounted in a number of ways. This in turn causes problems in ensuring the correct orientation of the fan when installed in the product. There are rarely any mechanical features preventing incorrect mounting. This can be a serious issue as it can result in a fan moving air in an incorrect direction if mounted the wrong way, dramatically altering cooling within the product. The proposed solution provides a way in which the apparatus itself may detect fault conditions (e.g. a fan mounted in the wrong way round when installed) thereby allowing a warning to be presented to the user. The reliability of the apparatus should therefore be improved through correctly mounted fans, reduction in customer's support calls and a reduced chance of damaged drives through thermal overload.

1. Apparatus comprising:
a processor, a plurality of devices and a plurality of temperature sensors, each sensor associated with a device, the processor being arranged in use to:
determine, for each of a plurality of sensors, the temperature of the associated device based on the temperature sensed by the sensor and the mode of operation of the device;
compare the determined temperatures for each device with stored data relating to the mode of operation of the apparatus; and
based on the comparison determine whether the apparatus is operating as expected in the mode of operation.

2. The apparatus of claim 1 wherein the stored data relates to an expected temperature profile of the determined temperatures for a mode of operation of the apparatus.

3. The apparatus of claim 2 wherein the stored data relates to an expected temperature profile of the determined temperatures for a mode of operation of the apparatus relating to a fan of the apparatus.

4. The apparatus of claim 1 further comprising at least one fan and wherein the stored data relates to an expected temperature profile of the determined temperatures when a fan is operating as expected.

5. The apparatus of claim 1 further comprising at least one fan and wherein the stored data relates to an expected temperature profile of the determined temperatures when the fan is installed incorrectly.

6. The apparatus of claim 1 further comprising at least one fan and wherein the stored data relates to an expected temperature profile of the determined temperatures when the bearings of a fan are worn.

7. The apparatus of claim 1 wherein the processor is further arranged to output an alert signal if it determines that the apparatus is not operating as expected.

8. The apparatus of claim 1 wherein at least one of the devices is an electronic device.

9. The apparatus of claim 8 wherein the determined temperature gives an estimation of the junction temperature of the device.

10. A method of monitoring the condition of an apparatus, the apparatus comprising a plurality of devices and a plurality of temperature sensors, each sensor associated with a device, the method comprising:
for each of a plurality of sensors, determining the temperature of the associated device based on the temperature sensed by the sensor and the mode of operation of the device; and
comparing the determined temperatures for each device with stored data relating to the mode of operation of the apparatus to determine whether the apparatus is operating as expected in the mode of operation.

11. The method of claim 10 wherein the stored data relates to an expected temperature profile of the determined temperatures for a mode of operation of the apparatus.

12. The method of claim 10 wherein the stored data relates to an expected temperature profile of the determined temperatures for a mode of operation of the apparatus relating to a fan of the apparatus.

13. The method of claim 10 further comprising at least one fan and wherein the stored data relates to an expected temperature profile of the determined temperatures when a fan is operating as expected.

14. The method of claim 10 further comprising at least one fan and wherein the stored data relates to an expected temperature profile of the determined temperatures when the fan is installed incorrectly.

15. The method of claim 10 further comprising at least one fan and wherein the stored data relates to an expected temperature profile of the determined temperatures when the bearings of a fan are worn.

16. The method of claim 10 further comprising outputting an alert signal when it is determined that the apparatus is not operating as expected.

17. The method of claim 10 wherein at least one of the devices is a semiconductor device.

18. The method of claim 17 wherein the determined temperature DTₙ gives an estimation of the junction temperature of the device.

19. A non-transitory computer-readable medium having computer-executable instructions adapted to cause a device to perform the method of claim 10.

20. A non-transitory data carrier carrying thereon or therein data indicative of instructions executable by processing means to cause those means to carry out a method according to claim 10.

21. The apparatus of claim 1 wherein the apparatus is a variable speed drive.

22. The method of claim 10 wherein the apparatus is a variable speed drive.
